(19) United States
(12) Patent Application Publication
(10) Pub. No.: US 2024/0380803 A1
(43) Pub. Date: Nov. 14, 2024

(54) Streaming Hub Assembly

(71) Applicant: Antoinette Brewer, Fairbanks, AK (US)

(72) Inventor: Antoinette Brewer, Fairbanks, AK (US)

(21) Appl. No.: 18/195,759

(22) Filed: May 10, 2023

(51) Int. Cl. H04L 65/60; H04B 7/15

(52) U.S. Cl. CPC H04L 65/60; H04B 7/15; H04W 88/18

(57) ABSTRACT

A streaming hub assembly includes a plurality of electronic devices positioned in a location typically occupied by a plurality of people. A plurality of transmitter units is each pluggable into a data port of a respective one of the electronic devices. Each of the transmitter units broadcasts a communication signal comprising an audio signal and a video signal from the respective electronic device. A repeater unit is provided and each of the transmitter units is in remote communication with the repeater unit. The repeater unit broadcasts the audio signal and the video signal to the personal electronic device. In this way a user of the personal electronic device can clearly hear the audio and clearly see the video from the respective electronic device.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to streaming devices and more particularly pertains to a new streaming device for facilitating audio and video from a plurality of electronic devices to be discretely streamed on a plurality of user's personal electronic devices. The device includes a plurality of transmitter units that can each be plugged into a respective electronic device and a repeater unit that is in wireless communication with each of the transmitter units. The repeater receives streaming audio and video from each of the transmitter units and the repeater is in wireless communication with one or more personal electronic devices. In this way the personal electronic devices can stream audio and video from a selected electronic device.

### (2) Description of Related Art Including Information Disclosed under 37 CFR 1.97 and 1.98

The prior art relates to streaming devices including a wireless audio and video playback system that includes a signal source, a transmitter, a plurality of wireless speakers and a wireless video receiver. The prior art discloses a connection management system that employs a logic circuit to manage routing of a signal between audio components. The prior art discloses a method for implementing wireless television which includes a local area interface, a wide area interface and a wireless transmission system for broadcasting to various personal electronic devices. The prior art discloses a wireless media player with has automated establishment of wireless connectivity with other electronic devices.

### BRIEF SUMMARY OF THE INVENTION

An embodiment of the disclosure meets the needs presented above by generally comprising a plurality of electronic devices positioned in a location typically occupied by a plurality of people. A plurality of transmitter units is each pluggable into a data port of a respective one of the electronic devices. Each of the transmitter units broadcasts a communication signal comprising an audio signal and a video signal from the respective electronic device. A repeater unit is provided and each of the transmitter units is in remote communication with the repeater unit. The repeater unit broadcasts the audio signal and the video signal to the personal electronic device. In this way a user of the personal electronic device can clearly hear the audio and clearly see the video from the respective electronic device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a streaming hub assembly according to an embodiment of the disclosure.

FIG. 2 is a top phantom view of a transmitter unit of an embodiment of the disclosure.

FIG. 3 is a top phantom view of a repeater unit of an embodiment of the disclosure.

FIG. 4 is a schematic view of an embodiment of the disclosure.

FIG. 5 is a front in-use view of an embodiment of the disclosure.

FIG. 6 is a perspective in-use view of an embodiment of the disclosure.

### DETAILED DESCRIPTION OF THE INVENTION

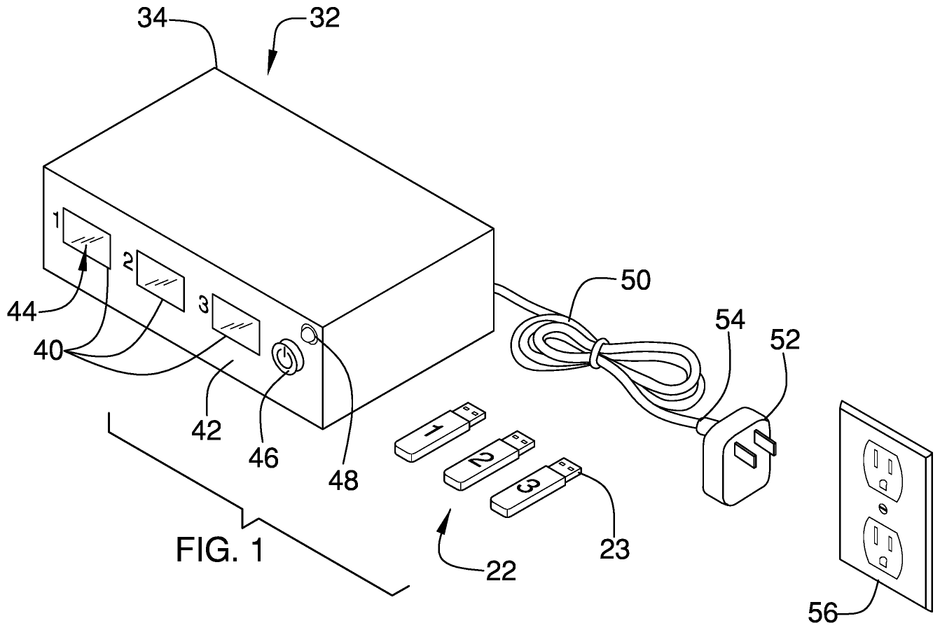

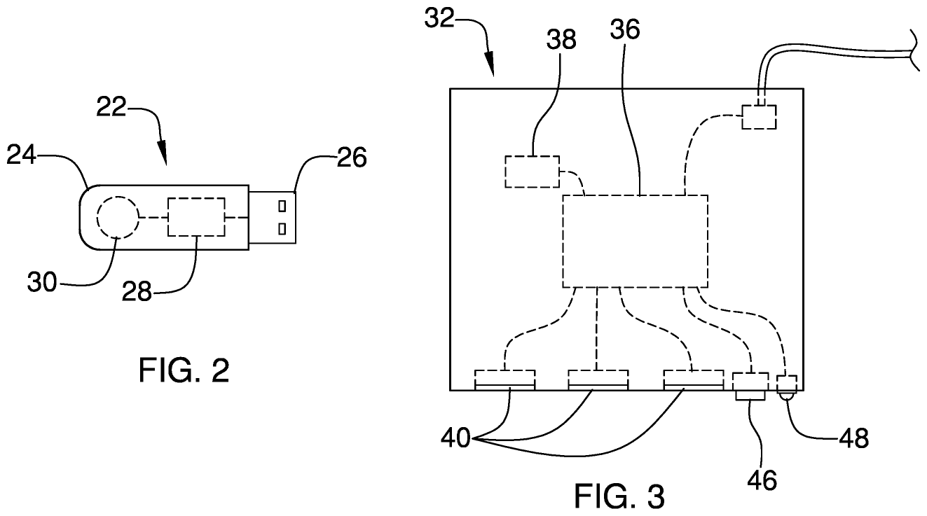

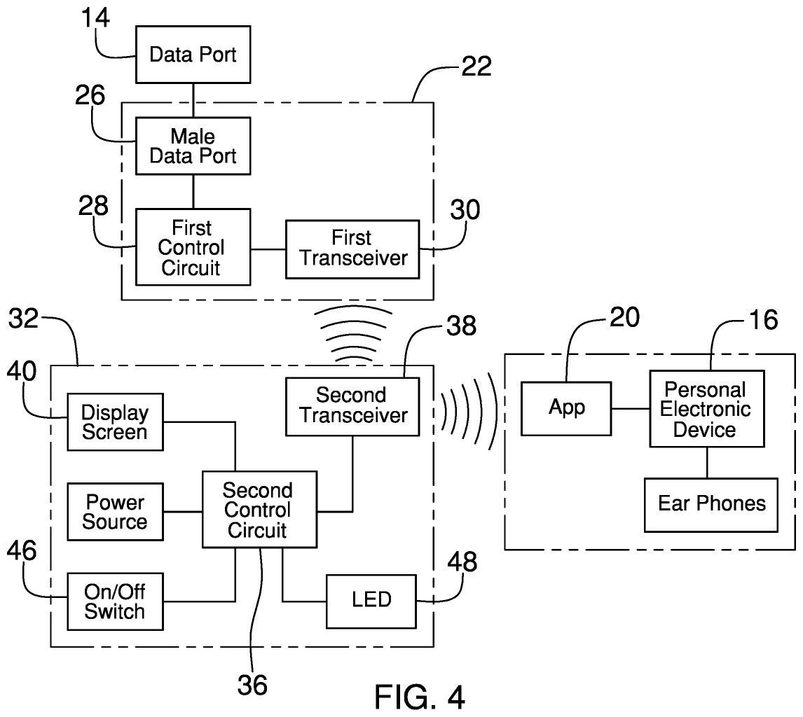

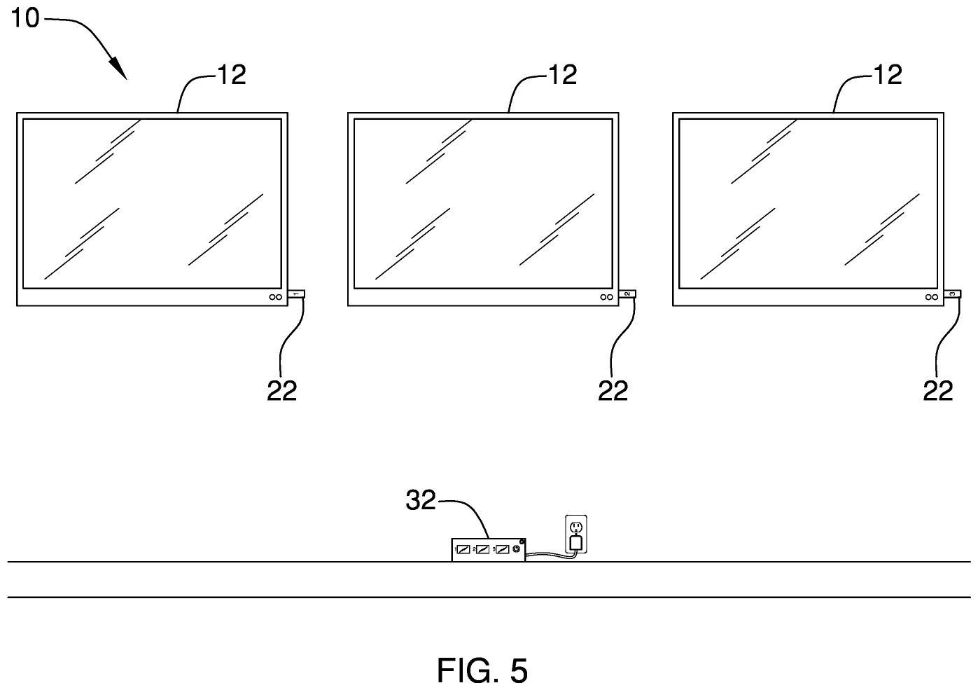

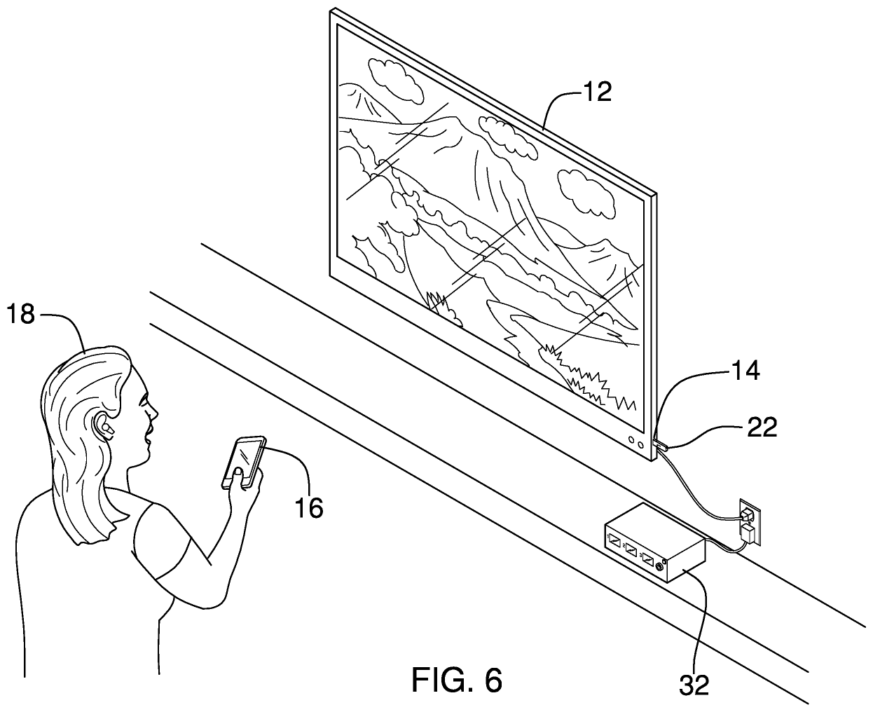

With reference now to the drawings, and in particular to FIGS. 1 through 6 thereof, a new streaming device embodying the principles and concepts of an embodiment of the disclosure and generally designated by the reference numeral 10 will be described.

As best illustrated in FIGS. 1 through 6, the streaming hub assembly 10 generally comprises a plurality of electronic devices 12 positioned in a location typically occupied by a plurality of people. The location may be a sports bar, for example, or other similar public location and the plurality of electronic devices 12 may comprise televisions or other types of electronic displays commonly employed for viewing streaming video or displaying broadcast network television. Each of the plurality of electronic devices 12 transmits an audio signal and a video signal and each of the plurality of electronic devices 12 has a data port 14 through which the audio signal and the video signal is communicated. A personal electronic device 16 is provided which is carried by a user 18 that is within a pre-determined maximum distance from the plurality of electronic devices 12. The personal electronic device 16 stores a communication application 20 and the personal electronic device 16 may comprise a smart phone or other type of electronic device that has wireless communication capabilities and multimedia streaming capabilities.

A plurality of transmitter units 22 is provided and each of the plurality of transmitter units 22 has an input plug 23 that is compatible with the data port 14 of a respective one of the electronic devices 12. In this way each of the plurality of transmitter units 22 can receive an audio signal and a video signal from the respective electronic device 12. Additionally, each of the transmitter units 22 broadcasts a communication signal. Each of the transmitter units 22 comprises a data stick 24 that has a male data port 26 which is matable with the data port 14 on the respective electronic device 12 such that the male data port 26 defines the input plug 23.

Each of the transmitter units 22 includes a first control circuit 28 that is integrated into the data stick 24 and the first control circuit 28 is electrically coupled to the male data port 26. In this way the first control circuit 28 is electrically coupled to the data port 14 when the male data port 26 is mated to the data port 14 thereby facilitating the first control circuit 28 to be powered by the respective electronic device 12. Each of the transmitter units 22 includes a first transceiver 30 that is integrated into the data stick 24 and the first transceiver 30 is electrically coupled to the first control circuit 28. The first transceiver 30 receives the audio signal and the video signal and the first transceiver 30 broadcasts the communication signal which comprises each of the audio signal and the video signal. Additionally, the first transceiver 30 may comprise a radio frequency transceiver or the like and the male data port 26 may comprise a universal serial bus port or other type of data port.

A repeater unit 32 is provided and the repeater unit 32 is positionable proximate the plurality of electronic devices 12. Each of the transmitter units 22 is in remote communication with the repeater unit 32 thereby facilitating the repeater unit 32 to receive the communication signal from each of the plurality of electronic devices 12. Furthermore, the repeater unit 32 broadcasts a plurality of connection signals thereby facilitating the plurality of connection signals to be received by the personal electronic device 16. Each of the connection signals is assigned to a respective one of the transmitter units 22 such that each of the connection signals carries the audio signal and the video signal received from the respective electronic device 12. In this way the personal electronic device 16 can receive the audio signal and the video signal from the respective electronic device 12 to facilitate the user 18 of the personal electronic device 16 to clearly hear the audio and clearly see the video from the respective electronic device 12.

The repeater unit 32 comprises a housing 34 that is positionable less than a pre-determined maximum distance from each of the plurality of electronic devices 12. The pre-determined maximum distance is determined by the effective operational range of the first transceiver 30 associated with each of the plurality of transmitter units 22. The repeater unit 32 includes a second control circuit 36 that is integrated into the housing 34 and a second transceiver 38 that is integrated into the housing 34. The second transceiver 38 is electrically coupled to the second control circuit 36 and the second transceiver 38 is in wireless communication with the first transceiver 30 associated with each of the plurality of transmitter units 22. In this way the second transceiver 38 receives the communication signal broadcast by the first transceiver 30 associated with each of the plurality of transmitter units 22. The second transceiver 38 may comprise a radio frequency transceiver or the like and the second transceiver 38 may employ Bluetooth communication protocols.

The second control circuit 36 assigns a unique identity to the first transceiver 30 associated with each of the transmitter units 22 and the second transceiver 38 is in wireless communication with the personal electronic device 16. The communication application 20 stored in the personal electronic device 16 facilitates the personal electronic device 16 to synchronize with the unique identity assigned to the first transceiver 30 associated with a respective transmitter unit 22. Thus, the personal electronic device 16 can receive the communication signal broadcast by the first transceiver 30 to which the personal electronic device 16 is synchronized. In this way the second transceiver 38 facilitates the user 18 synchronize the personal electronic device 16 with a chosen one of the plurality of electronic devices 12.

The repeater unit 32 includes a plurality of displays 40 that is each integrated into a front wall 42 of the housing 34. Each of the displays 40 is electrically coupled to the second control circuit 36 and each of the displays 40 is assigned to a respective one of the transmitter units 22. Each of the displays 40 can display indicia 44 comprising numbers and text to indicate operational parameters of the respective transmitter unit 22. Additionally, each of the plurality of displays 40 may comprise a light emitting diode display or other type of electronic display.

A power switch 46 is movably integrated into the front wall 42 of the housing 34 and the power switch 46 is electrically coupled to the second control circuit 36. The power switch 46 is positionable between an on position and an off position for turning the second control circuit 36 on and off. A is integrated into the front wall 42 of the housing 34 to emit light outwardly from the housing 34. The light emitter 48 is electrically coupled to the second control circuit 36 and the light emitter 48 is turned on when the second control circuit 36 is turned on to visually communicate that the second control circuit 36 is active. The light emitter 48 may comprise a light emitting diode or other similar type of electronic light emitter 48. The repeater unit 32 includes a power cord 50 which extends away from the housing 34 and the power cord 50 is electrically coupled to the power switch 46. The power cord 50 has a male plug 52 that is electrically coupled to a distal end 54 of the power cord 50 with respect to the housing 34. In this way the male plug 52 can be matable to a power source 56 comprising a female electrical outlet.

In use, each of the transmitter units 22 is plugged into the respective electronic device 12 such that each of the transmitter units 22 broadcasts the audio signal and the video signal from the respective electronic device 12 to the repeater unit 32. The communication application 20 on the personal electronic device 16 is manipulated to choose which of the transmitter units 22 the personal electronic device 16 will be synchronized with via the repeater unit 32. In this way the personal electronic device 16 can stream the audio and video from respective electronic device 12 to facilitate the user 18 to hear the audio in a loud environment, such as a sports bar for example. Furthermore, the user 18 may employ headphones with the personal electronic device 16 to further enhance their ability to hear the audio from the respective electronic device 12. Additionally, the repeater unit 32 facilitates a large number of users to synchronize their personal electronic device 16 with any of the transmitter units 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A streaming hub assembly for facilitating an electronic device to be wirelessly connected to a plurality of personal electronic devices for streaming audio and video to the plurality of personal electronic devices, said assembly comprising:
a plurality of electronic devices being positioned in a location typically occupied by a plurality of people, each of said plurality of electronic devices transmitting an audio signal and a video signal;
a personal electronic device being configured to be carried by a user that is within a pre-determined maximum distance from said plurality of electronic devices;
a plurality of transmitter units, each of said plurality of transmitter units having an input plug being compatible with said data port of a respective one of said electronic devices wherein thereby facilitating each of said plurality of transmitter units to receive an audio signal and a video signal from said respective electronic device, each of said transmitter units broadcasting a communication signal, each transmitter unit comprising a first control circuit being integrated into a data stick;
a repeater unit being positionable proximate said plurality of electronic devices, each of said transmitter units being in remote communication with said repeater unit thereby facilitating said repeater unit to receive said communication signal from each of said plurality of electronic devices, said repeater unit broadcasting a plurality of connection signals thereby facilitating said plurality of connection signals to be received by said personal electronic device, each of said connection signals being assigned to a respective one of said transmitter units such that each of said connection signals carries said audio signal and said video signal received from said respective electronic device thereby facilitating said personal electronic device to receive said audio signal and said video signal from said respective electronic device wherein said repeater unit is configured to facilitate a user of said personal electronic device to clearly hear the audio and clearly see the video from said respective electronic device;
wherein each of said plurality of transmitter units includes a first transceiver;
wherein said repeater unit comprises:
a housing being positionable less than a pre-determined maximum distance from each of said plurality of electronic devices;
a second control circuit being integrated into said housing; and
a second transceiver being integrated into said housing, said second transceiver being electrically coupled to said second control circuit, said second transceiver being in wireless communication with said first transceiver associated with each of said plurality of transmitter units such that said second transceiver receives said communication signal broadcast by said first transceiver associated with each of said plurality of transmitter units;
wherein said second control circuit assigns a unique identity to said first transceiver associated with each of said transmitter units, said second transceiver being in wireless communication with said personal electronic device; and
wherein said repeater unit includes:
a power switch being movably integrated into said front wall of said housing, said power switch being electrically coupled to said second control circuit, said power switch being positionable between an on position and an off position for turning said second control circuit on and off;
a light emitter being integrated into said front wall of said housing wherein said light emitter is configured to emit light outwardly from said housing, said light emitter being electrically coupled to said second control circuit, said light emitter being turned on when said second control circuit is turned on wherein said light emitter is configured to visually communicate that said second control circuit is active; and
a power cord extending away from said housing, said power cord being electrically coupled to said power switch, said power cord having a male plug being electrically coupled to a distal end of said power cord with respect to said housing wherein said male plug is configured to be matable to a power source comprising a female electrical outlet.

2. The assembly according to claim 1, wherein:
cach of said plurality of electronic devices has a data port; and
each of said transmitter units comprises:
said data stick having a male data port being matable with said data port on said respective electronic device such that said male data port defines said input plug;
said first control circuit being electrically coupled to said male data port such that said first control circuit is electrically coupled to the data port when said male data port is mated to said data port thereby facilitating said first control circuit to be powered by said respective electronic device; and
a first transceiver being integrated into said data stick, said first transceiver being electrically coupled to said first control circuit, said first transceiver receiving said audio signal and said video signal, said first transceiver broadcasting said communication signal which comprises each of said audio signal and said video signal.

3. (canceled)

4. (canceled)

5. The assembly according to claim 1, wherein said personal electronic device stores a communication application, said communication application stored in said personal electronic device facilitating said personal electronic device to synchronize with said unique identity assigned to said first transceiver associated with a respective transmitter unit, said personal electronic device receiving said communication signal broadcast by said first transceiver to which said personal electronic device is synchronized wherein said second transceiver is configured to facilitate the user synchronize said personal electronic device with a chosen one of said plurality of electronic devices.

6. The assembly according to claim 1, wherein said repeater unit includes a plurality of displays, each of said plurality of displays being integrated into a front wall of said housing, each of said displays being electrically coupled to said second control circuit, each of said displays being assigned to a respective one of said transmitter units, each of said displays displaying indicia comprising numbers and text to indicate operational parameters of said respective transmitter unit.

7. (canceled)

8. A streaming hub assembly for facilitating an electronic device to be wirelessly connected to a plurality of personal electronic devices for streaming audio and video to the plurality of personal electronic devices, said assembly comprising:
a plurality of electronic devices being positioned in a location typically occupied by a plurality of people, each of said plurality of electronic devices transmitting an audio signal and a video signal, each of said plurality of electronic devices having a data port;
a personal electronic device being configured to be carried by a user that is within a pre-determined maximum distance from said plurality of electronic devices, said personal electronic device storing a communication application;
a plurality of transmitter units, each of said plurality of transmitter units having an input plug being compatible with said data port of a respective one of said electronic devices wherein thereby facilitating each of said plurality of transmitter units to receive an audio signal and a video signal from said respective electronic device, each of said transmitter units broadcasting a communication signal, each of said transmitter units comprising:
a data stick having a male data port being matable with said data port on said respective electronic device such that said male data port defines said input plug;
a first control circuit being integrated into said data stick, said first control circuit being electrically coupled to said male data port such that said first control circuit is electrically coupled to the data port when said male data port is mated to said data port thereby facilitating said first control circuit to be powered by said respective electronic device; and
a first transceiver being integrated into said data stick, said first transceiver being electrically coupled to said first control circuit, said first transceiver receiving said audio signal and said video signal, said first transceiver broadcasting said communication signal which comprises each of said audio signal and said video signal;
a repeater unit being positionable proximate said plurality of electronic devices, each of said transmitter units being in remote communication with said repeater unit thereby facilitating said repeater unit to receive said communication signal from each of said plurality of electronic devices, said repeater unit broadcasting a plurality of connection signals thereby facilitating said plurality of connection signals to be received by said personal electronic device, each of said connection signals being assigned to a respective one of said transmitter units such that each of said connection signals carries said audio signal and said video signal received from said respective electronic device thereby facilitating said personal electronic device to receive said audio signal and said video signal from to facilitate a user of said personal electronic device to clearly hear the audio and clearly see the video from said respective electronic device, said repeater unit comprising:
a housing being positionable less than a pre-determined maximum distance from each of said plurality of electronic devices;
a second control circuit being integrated into said housing;
a second transceiver being integrated into said housing, said second transceiver being electrically coupled to said second control circuit, said second transceiver being in wireless communication with said first transceiver associated with each of said plurality of transmitter units such that said second transceiver receives said communication signal broadcast by said first transceiver associated with each of said plurality of transmitter units, said second control circuit assigning a unique identity to said first transceiver associated with each of said transmitter units, said second transceiver being in wireless communication with said personal electronic device, said communication application stored in said personal electronic device facilitating said personal electronic device to synchronize with said unique identity assigned to said first transceiver associated with a respective transmitter unit, said personal electronic device receiving said communication signal broadcast by said first transceiver to which said personal electronic device is synchronized wherein said second transceiver is configured to facilitate the user synchronize said personal electronic device with a chosen one of said plurality of electronic devices;
a plurality of displays, each of said plurality of displays being integrated into a front wall of said housing, each of said displays being electrically coupled to said second control circuit, each of said displays being assigned to a respective one of said transmitter units, each of said displays displaying indicia comprising numbers and text to indicate operational parameters of said respective transmitter unit;
a power switch being movably integrated into said front wall of said housing, said power switch being electrically coupled to said second control circuit, said power switch being positionable between an on position and an off position for turning said second control circuit on and off;
a light emitter being integrated into said front wall of said housing wherein said light emitter is configured to emit light outwardly from said housing, said light emitter being electrically coupled to said second control circuit, said light emitter being turned on when said second control circuit is turned on wherein said light emitter is configured to visually communicate that said second control circuit is active; and
a power cord extending away from said housing, said power cord being electrically coupled to said power switch, said power cord having a male plug being electrically coupled to a distal end of said power cord with respect to said housing wherein said male plug is configured to be matable to a power source comprising a female electrical outlet.
